(19) United States
(12) Patent Application Publication
(10) Pub. No.: US 2005/0006156 A1
(43) Pub. Date: Jan. 13, 2005

(54) Hood positioning apparatus and method

(76) Inventor: Darren M. Schambach, Elburn, IL (US)

Correspondence Address: CATERPILLAR INC.;100 N.E. ADAMS STREET, PATENT DEPT., PEORIA, IL, 616296490, US

(21) Appl. No.: 10/616,686

(22) Filed: Jul. 10, 2003

(51) Int. Cl. B62D 25/10

(52) U.S. Cl. 180/69.2

(57) ABSTRACT

A hood raising apparatus for a hood of a vehicle of the type having a frame and at least one fluid powered actuator coupled to the hood and the frame, and a circuit in communication with the actuator and structured and arranged to control the actuator for raising or lowering the hood.

### TECHNICAL FIELD

The present invention is directed to a hood positioning apparatus and method and, more specifically, a hood positioning apparatus and method thereof for raising or lowering hoods that may be impracticable to raise or lower manually.

### BACKGROUND

In general, vehicles are provided with compartments such as engine compartments which are typically used in conjunction with hoods which, in turn, are used to at least partially cover the compartment and to protect the contents of the compartment such as the engine and supporting componentry from dust, debris, weather, theft, etc. Engine compartments may also be covered to contain noise and route cooling air flow. Such compartments are generally kept covered by hoods in normal use of the vehicle and in storage, but must be opened to provide access for periodic maintenance and inspection and for repairs. However, engine compartment hoods of work vehicles such as wheeloaders, tractors, and the like, are typically large and very heavy and can require significant reach and effort to manually open and close.

There have been prior art attempts to provide some form of mechanical assist in moving hoods. One such example can be found in U.S. Pat. No. 6,167,977 which issued on Jan. 2, 2001, to Adamson et al. which teaches the use of gas struts to provide a biasing force to assist in raising the hood. Although adequate for its intended purpose of assisting in raising the hood, this design does not provide assistance in thereafter lowering the hood. Furthermore, these devices may be limited in the amount of biasing force they can generate thereby making them impracticable for very heavy hoods.

The present invention is directed to overcoming one or more of the problems as set forth above.

### SUMMARY OF THE INVENTION

In accordance with an embodiment of the present invention, a hood raising apparatus for a hood of a vehicle of the type having a frame is provided and comprises at least one fluid powered actuator coupled to the hood and the frame; and a circuit in communication with the actuator and structured and arranged to control the actuator.

In accordance with another embodiment of the present invention, a method of positioning a hood of a vehicle, of the type having a frame, is provided comprising the steps of providing at least one fluid powered actuator coupled to the hood and the frame, and providing a circuit coupled to the fluid powered actuator and structured and arranged to control the actuator to perform at least one of raise and lower of the hood.

### BRIEF DESCRIPTION OF THE DRAWINGS

FIG. 1 is an elevation view of a vehicle incorporating an embodiment of a hood positioning apparatus of the present invention; and

FIG. 2 is diagrammatical view of an embodiment of a circuit used with the hood positioning apparatus of the present invention.

### DETAILED DESCRIPTION

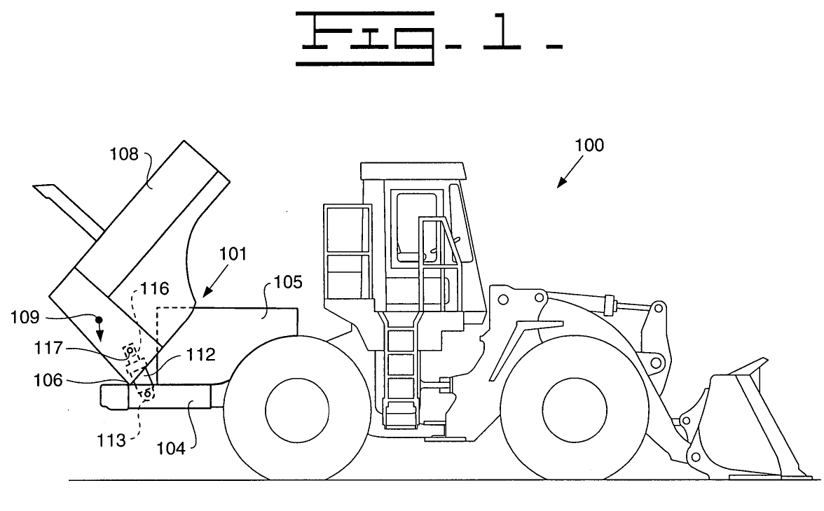

With reference to the Figures, shown in FIG. 1 is a vehicle 100, embodied herein for exemplary purposes by a wheel loader-type work machine, incorporating the hood positioning apparatus 101 of the present invention. For exemplary purposes, those relevant portions of the vehicle 100 useful or necessary to fully describe the present invention will be discussed herein. Shown is the vehicle 100 having a frame 104 used to support a prime mover or engine 105. Pivotally coupled to the frame 104 at attachment point 106 is a hood 108, having a center of gravity 109, that is shown in the raised position and that is used to house the engine 105. A pair of actuators each embodied herein by a hydraulic cylinder 112 (one shown) couple the hood 108 to each side of the frame 104. In view of the fact that each hydraulic cylinder 112 is substantially the same and used in substantially the same manner, only one hydraulic cylinder 112 will be referenced herein. For purposes of illustration and not limitation, each hydraulic cylinder 112 comprises a double-acting hydraulic cylinder having a cap end 113 coupled to the frame 104 and a rod end 116 coupled to the hood 108 at a pivotal attachment point 117.

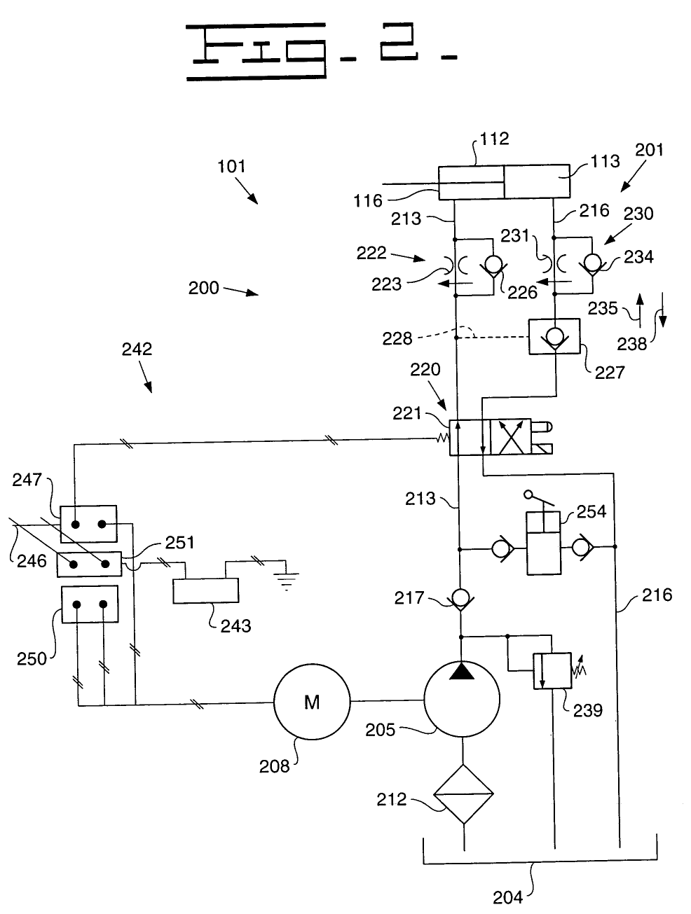

With reference to FIG. 2, an embodiment of the circuit 200 used to control the hood positioning apparatus 101 of the present invention will now be described. For purposes of clarification, solid lines shown in FIG. 2 represent fluid channels and solid lines with the double hash marks shall represent electrical channels. As shown, the circuit 200 comprises a hydraulic portion 201 that includes a reservoir 204 used to store hydraulic fluid. A pump 205, driven by motor 208, draws fluid from the reservoir 204 in a known manner. A filter 212 may be provided to prevent potentially damaging particulates from entering the pump 205. A first hydraulic line 213 is coupled to the rod end 116 of the hydraulic cylinder 112, and a second hydraulic line 216 is coupled to the cap end 113 of the hydraulic cylinder 112. Upon exiting the pump 205, fluid travels through a flow prevention device or check valve 217 and passes through a directional control valve 220, having a moveable spool 221, and may either continue to pass though the first hydraulic line 213 or be diverted to the second hydraulic line 216 depending on the whether the circuit 200 has been orientated to raise or lower the hood 108.

If the fluid is oriented to continue through the first hydraulic line 213, prior to entering the rod end 116 of the hydraulic cylinder 112, fluid flow passes through a first flow control device 222 which comprises a flow metering portion 223, having a first flow control characteristic, and having an flow prevention portion 226 that is embodied herein by a check valve. In the event that flow is diverted to the second hydraulic line 216, fluid passes though a flow prevention device embodied herein by a pilot operated check valve 227, having a pilot pressure line 228 for communicating a source of pressure to the pilot operated check valve 227, and then through a second flow control device 230 prior to reaching the cap end 113 of the hydraulic cylinder 112. The second flow control device 230 also comprises a flow metering portion 231, having a second flow control characteristic, and a flow prevention portion 234 that is also embodied herein by a check valve. For exemplary purposes only, the first and second flow control devices 222,230 are embodied herein by pressure-compensated flow control valves. However, any device capable of exhibiting one or more of flow metering and flow prevention characteristics is contemplated to be within the scope of the present invention.

As used herein, the term “flow control characteristic” refers to the rate of flow allowed through a respective flow control device. In an embodiment of the present invention the second flow control device 230 has a second fluid flow characteristic that is greater than the first flow characteristic of the first flow control device 222 with each respective flow characteristics chosen to allow the hood 108 to raise and lower at approximately the same rate. As should be appreciated by those of ordinary skill in such art, the flow characteristics of the flow metering portions 223, 231 may be optimized or otherwise adjusted to provide the desired rate of ascent of descent of the hood 108. Furthermore, as should be apparent to those of ordinary skill in such art, the provision of each of the respective flow control device 222,230 provide for free or unregulated flow in each respective hydraulic line 213, 216 when the fluid flow is in the direction of arrow 235, and provides for regulated or metered flow through the respective flow metering portions 223,231 when the fluid flow is in the direction of arrow 238. In the event excess pressure develops in the hydraulic portion 201, a relief valve 239 is provided to bleed off the excess pressure in a known manner.

With further reference to FIG. 2, the electrical portion 242 of the circuit 200 will now be described. Energy is provided to the motor 208 by means of a power source comprising in an embodiment of the present invention a battery 243. A switching device 246, which may comprise a toggle switch or other like activation device, is provided and is manipulated in a known manner to raise, lower or hold the position of hood 108 in a desired location. For the exemplary circuit 200 illustrated and described herein, placing the switching device 246 in the raise or first position denoted 247 will result in the raising of the hood 108. Placing the switching device 246 in the lower or second position denoted 250 will result in the lowering of the hood 108; and placing the switching device 246 in the neutral or third position denoted 251 will result in the hood 108 being maintained in the then current position. In the event of a failure of the electrical portion 242 of the circuit 200, a backup power device such as a manual pumping device 254 is provided to move the hood 108 in a known manner.

### INDUSTRIAL APPLICABILITY

The hood positioning apparatus 101 of the present invention has been described herein for use with raising or lowering of hoods 108 that may be too large or unwieldy to be manipulated manually. However, as should be apparent to those of ordinary skill in such art, the hood positioning apparatus 101 of the present invention may be used to raise and lower hoods of any shape and size.

Activation of the hood positioning apparatus 101 is initiated by manipulating the switching device 246 in the desired manner. To raise the hood 108, the switching device 246 is placed in the first position denoted 247 thereby energizing both the motor 208 and the directional control valve 220. Activation of the directional control valve 220 causes the spool 221 of the directional control valve 220 to shift left (as shown in FIG. 2 for illustrative purposes only) thereby diverting hydraulic fluid to the second hydraulic line 216. Pressure thereafter builds in the cap end 113 of the hydraulic cylinder 112 until such time as the pressure in the cap end 113 exceeds the combined weight of the hood 108 and any environmental forces acting on the hood 108 such as any wind, at which point the hood 108 shall begin to rise.

Placing the switching device 246 in the third position 251 allows the operator to stop the movement of the hood 108 anytime during its ascent or descent. Placing the switching device 246 in the third position 251 turns off the motor 208, thereby ceasing flow of fluid in the hydraulic portion 201 of the circuit 200, and deactivates the directional control valve 220 which causes the spool 221 to automatically shift to its neutral position shown in FIG. 2. The provision of the check valves 217 and 227 prevent fluid flow, and hence pressure loss, out of both the rod end 116 and the cap end 113 of the hydraulic cylinder 112 thereby allowing the hood 108 to be being maintained in its stopped position.

Finally, to lower the hood 108, the switching device 246 is placed in the second position 250 which activates motor 208 allowing the pump 205 to supply pressurized fluid to the rod end 116 of the hydraulic cylinder 112. Because fluid flow out of the cap end 113 is in the direction of arrow 238, the fluid flow is prevented from flowing freely through the second flow control device 230 but rather is regulated by virtue of the flow metering portion 231. Hydraulic pressure in the first hydraulic line 213 is communicated to the pilot operated check valve 227 via pilot pressure line 228 which opens the pilot operated check valve 227, thereby permitting the passage of fluid out of the cap end 113 resulting in the lowering of the hood 108.

Also, and as should also be appreciated by those of ordinary skill in such art, the provision of the first flow control device 222 allows for controlled movement of the hood 108 when the center of gravity 109 of the hood 108 passes over, and is thereby located behind, the attachment point 106 of the hood 108 (as shown in FIG. 1). In other words, once the center of gravity 109 passes over the attachment point 106, the weight of the hood 108 is no longer providing a reactionary load acting on the hydraulic cylinder 112, but rather providing a “pulling” force on the hydraulic cylinder 112 which would cause the hood 108 to continue to raise at an accelerated and uncontrolled rate. By incorporating the first flow control device 222 into the circuit 200, the rate of evacuation of fluid pressure from the rod end 116 is limited by the maximum flow rate through the first flow control device 222.

Other aspects, objects and advantages of this invention can be obtained from a study of the drawings, the disclosure and the appended claims.

1. A hood positioning apparatus for a hood of a vehicle of the type having a frame, comprising:
at least one fluid powered actuator coupled to the hood and the frame; and
a circuit in communication with said actuator and structured and arranged to control said actuator.

2. The hood positioning apparatus as set forth in claim 1 further comprising a backup power device in fluid communication with said actuator.

3. The hood positioning apparatus as set forth in claim 2 wherein said backup power device comprises a manually actuated pumping device.

4. The hood positioning apparatus as set forth in claim 1 wherein said circuit comprises an electro-hydraulic circuit.

5. The hood positioning apparatus as set forth in claim 1 wherein said circuit comprises at least one flow control device in fluid communication with said actuator.

6. The hood positioning apparatus as set forth in claim 1 wherein said actuator is a hydraulic cylinder.

7. The hood positioning apparatus as set forth in claim 1 wherein:
said actuator is a hydraulic cylinder having a rod end and a cap end; and
said circuit comprises a flow control device in fluid communication with at least one of said rod end and said cap end.

8. The hood positioning apparatus as set forth in claim 7 wherein said circuit further includes a flow prevention device in fluid communication with one of said cap end and said rod end and actuatable to decrease said fluid pressure in said cap end or said rod end in response to pressure.

9. The hood positioning apparatus as set forth in claim 7 wherein said flow control device comprises a flow prevention portion.

10. The hood positioning apparatus as set forth in claim 7 wherein said flow control device comprises a flow metering portion.

11. The hood positioning apparatus as set forth in claim 1 wherein:
said actuator comprises a rod end coupled to the hood, and a cap end coupled to the frame;
said circuit comprises a first flow control device in fluid communication with said rod end;
said circuit comprises a second flow control device in fluid communication with said cap end; and
said circuit further includes a flow prevention device in fluid communication with both said cap end and said rod end and actuatable to decrease said fluid pressure in said cap end in response to fluid pressure at said rod end.

12. The hood positioning apparatus as set forth in claim 11 wherein said flow prevention device comprises a pilot operated check valve.

13. A method of positioning a hood of a vehicle of the type having a frame, comprising the steps of:
providing at least one fluid powered actuator coupled to the hood at an attachment point and coupled to the frame; and
providing a circuit coupled to the fluid powered actuator and structured and arranged to control said actuator to perform at least one of raise and lower of said hood.

14. The method as set forth in claim 13 further comprising the steps of:
providing an attachment point of the hood with the frame; and
providing said circuit with a flow control device structured and arranged to control the rate of movement of the hood when said center of gravity of the hood passes over said attachment point.

15. The method as set forth in claim 13 further comprising the step of providing a backup power device structured and arranged to manually control said actuator.

16. The method as set forth in claim 15 wherein said backup power device comprises a manual pumping device.

17. The method as set forth in claim 13 further comprising the steps of:
placing said circuit in at least one of a raise, lower or neutral position;
wherein said actuator has an end for receiving an amount of pressure thereby raising the hood when said circuit is placed in said raise position; and
wherein said end substantially maintains said pressure when said circuit is placed in said neutral position.

18. The method as set forth in claim 17 wherein said pressure in said end decreases when said circuit is placed in a lower position.
